(19) United States
(12) Patent Application Publication
(10) Pub. No.: US 2024/0089798 A1
(43) Pub. Date: Mar. 14, 2024

(54) MESH-LINK TRAFFIC SEGMENTATION BASED ON PRIORITY

(71) Applicant: ARRIS Enterprises LLC, Suwanee, GA (US)

(72) Inventors: Ravi Kiran Mattaparti, Cupertino, CA (US); Hemant Bhatnagar, Cupertino, CA (US); Virendra Malaviya, Cupertino, CA (US)

(73) Assignee: ARRIS Enterprises LLC, Suwanee, GA (US)

(21) Appl. No.: 18/462,593

(22) Filed: Sep. 7, 2023

Related U.S. Application Data
(60) Provisional application No. 63/404,576, filed on Sep. 8, 2022.

(51) Int. Cl. H04W 28/20; H04W 72/0453; H04W 72/566

(52) U.S. Cl. CPC H04W 28/20; H04W 72/0453; H04W 72/569

(57) ABSTRACT

A root access point (RAP) that communicates with one or more mesh access points (MAPs) via two or more concurrent mesh links (or paths) in a mesh network is described. Notably, during operation, the RAP may communicate, via a mesh link in the two or more concurrent mesh links, packets or frames with the one or more MAPs, where the mesh link uses a band of frequencies, and where the packets or frames have a priority. Moreover, the RAP may communicate, via a second mesh link in the two or more concurrent mesh links, second packets or second frames with the one or more MAPs, where the second mesh link uses a second band of frequencies that is different from the currently selected band of frequencies, and where the second packets or second frames have a second priority that is less than the priority of the packets or frames.

### CROSS REFERENCE TO RELATED APPLICATIONS

This application claims priority under 35 U.S.C. 119(e) to U.S. Provisional Application Ser. No. 63/404,576, “Mesh-Link Traffic Segmentation Based on Priority,” filed on Sep. 8, 2022, by Ravi Kiran Mattaparti, et al., the contents of which are herein incorporated by reference.

### FIELD

The described embodiments relate to techniques for communicating information in a mesh network. More specifically, the described embodiments relate to techniques for segmenting traffic to different links in a mesh network based at least in part on traffic priority.

### BACKGROUND

Many electronic devices are capable of wirelessly communicating with other electronic devices. For example, these electronic devices can include a networking subsystem that implements a network interface for: a cellular network (e.g., 3GPP UMTS, LTE, 5G/5GNC, etc.), a wireless local area network (e.g., a wireless network such as described in the Institute of Electrical and Electronics Engineers (IEEE) 802.11 standard or Bluetooth from the Bluetooth Special Interest Group of Kirkland, Washington), and/or another type of wireless network.

One approach to wireless communication is to use a wireless mesh network (which is henceforth referred to as a ‘mesh network’). In a mesh network, multiple mesh access points or MAPs (which are sometimes referred to as ‘nodes’) are organized in a mesh topology in which electronic devices or clients communicate with each other via zero or more intermediate MAPs or nodes. The wireless clients served by a root access point (RAP) or root node via mesh paths/links can communicate to an external network (such as a packet data network (PDN), e.g., the Internet) and vice versa.

In addition to multiple mesh paths through a mesh network, there are often multiple active links or paths (e.g., using a band of frequencies, such as a 2.4, 5 or 6 GHz band of frequencies) to the external network via one or more RAPs in the mesh network. This configuration allows packets or frames to be forwarded to external electronic devices, such as a switch, a router, or a controller.

Based on radio-frequency (RF) conditions, it often takes time to update routes (e.g., mesh link/path) in a mesh network to the MAPs. Therefore, the mesh-network topology is typically quasi-static. Overtime, the mesh paths through the mesh network converge, so data can be delivered to destinations optimally. Consequently, many mesh networks are a low-mobility centralized form of a wireless ad-hoc network.

However, the quasi-static nature of many existing mesh network can adversely impact the communication performance (such as the throughput) and, thus, the quality of experience (QoE) of clients that connect to a MAP. For example, a link between the MAP and a RAP may become saturated because of prevailing RF conditions, an increase in the number of clients that are served by the MAP. Existing mesh networks typically do not adapt to address these problems.

Moreover, the communication problems in existing mesh networks may be increased for certain types of applications, such as: voice over Internet Protocol (VoIP) and video conferencing. This is because these applications may need additional resources (such as increased bandwidth, extra airtime, etc.) in order to provide expected quality of experience to clients. However, once again, the inflexible nature of many existing mesh network often results in a reduction in the quality of experience, especially during busy usage.

### SUMMARY

A RAP that communicates with one or more MAPs via two or more concurrent mesh links (or paths) in a mesh network is described. This RAP includes: one or more interface circuits that communicates with the one or more MAPs in the mesh network via the two or more concurrent mesh links and one or more electronic devices in a wired network. Notably, during operation, the RAP communicates, via a mesh link in the two or more concurrent mesh links, packets or frames with the one or more MAPs, where the mesh link uses a band of frequencies, and where the packets or frames have a priority. Moreover, the RAP communicates, via a second mesh link in the two or more concurrent mesh links, second packets or second frames with the one or more MAPs, where the second mesh link uses a second band of frequencies that is different from the band of frequencies, and where the second packets or second frames have a second priority that is less than the priority.

Note that the band of frequencies may include a 6 GHz band of frequencies, and the second band of frequencies may include a 2.4 or 5 GHz band of frequencies.

Moreover, the one or more MAPs may include two MAPs.

Furthermore, the priority may be associated with a type of application and the second priority may be associated with a second type of application that is different from the type of application. Additionally, the type of application may include voice (such as VoIP), video (such as a video-conferencing application) or file download.

In some embodiments, the priority may be specified by an access category associated with the packets or frames and the second priority may be specified by a second access category associated with the second packets or second frames.

Moreover, in some embodiments, the RAP receives, associated with a controller of the RAP or a computer (such as a cloud-based computer), information that specifies the priority and the second priority. Furthermore, the information may be associated with traffic flows between the one or more electronic devices and the RAP, where a traffic flow in the traffic flows includes the packets or frames and second traffic flow in the traffic flows includes the second packets or second frames. For example, the information may be associated with communication-performance metrics associated with the traffic flows. Additionally, the information may be received before the traffic flows begin. In some embodiments, the information may specify the link and the second link.

Note that the communication of the packets or the frames and the second packets or second frames may be compatible with an IEEE 802.11 communication protocol, such as: IEEE 802.11a, IEEE 802.11b, IEEE 802.11g, IEEE 802.11n, IEEE 802.11ac, IEEE 802.11ax, IEEE 802.11be, IEEE 802.11s, etc.

Another embodiment provides the controller or the computer that performs counterpart operations to at least some of the aforementioned operations. This controller or the computer may compute the information using a pretrained predictive model. Note that the pretrained predictive model uses the communication-performance metrics or second information associated with the traffic flows as inputs and may output the information. Moreover, the controller or the computer may dynamically retrain the pretrained predictive model based at least in part on data associated with the traffic flows.

Another embodiment provides the one or more MAPs that perform counterpart operations to at least some of the aforementioned operations.

Another embodiment provides a computer-readable storage medium for use with the RAP, a given MAP, the controller or the computer. This computer-readable storage medium may include program instructions that, when executed by the RAP, the given MAP, the controller or the computer, cause the RAP, the given MAP, the controller or the computer to perform at least some of the aforementioned operations.

Another embodiment provides a method. This method includes at least some of the operations performed by the RAP, the given MAP, the controller or the computer.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is a block diagram illustrating an example of a system in accordance with an embodiment of the present disclosure.

FIG. 2 is a flow diagram illustrating an example method for communicating in a mesh network in the system in FIG. 1 in accordance with an embodiment of the present disclosure.

FIG. 3 is a drawing illustrating an example of communication among electronic devices in FIG. 1 in accordance with an embodiment of the present disclosure.

FIG. 4 is a drawing illustrating an example of communication in a mesh network in FIG. 1 in accordance with an embodiment of the present disclosure.

FIG. 5 is a drawing illustrating an example of communication in a mesh network in FIG. 1 in accordance with an embodiment of the present disclosure.

FIG. 6 is a drawing illustrating an example of communication in a mesh network in FIG. 1 in accordance with an embodiment of the present disclosure.

FIG. 7 is a block diagram illustrating an example of an electronic device in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

A RAP that communicates with one or more MAPs via two or more concurrent mesh links (or paths) in a mesh network is described. Notably, during operation, the RAP may communicate, via a mesh link in the two or more concurrent mesh links, packets or frames with the one or more MAPs, where the mesh link uses a band of frequencies, and where the packets or frames have a priority. Moreover, the RAP may communicate, via a second mesh link in the two or more concurrent mesh links, second packets or second frames with the one or more MAPs, where the second mesh link uses a second band of frequencies that is different from the band of frequencies, and where the second packets or second frames have a second priority that is less than the priority of the packets or frames.

By communicating the packets or frames and the second packets or frames using different bands of frequencies, these communication techniques may improve communication performance in the mesh network. Notably, the higher-priority packets or frames may be communicated using the band of frequencies with an improved communication-performance metric (such as improved throughput) relative to the second band of frequencies, and/or the band of frequencies may not be subject to dynamic frequency selection (DFS), while the second band of frequencies may be subject to DFS. Moreover, the assignment or selection of the communication of the packets or frames via the mesh link and the communication of the second packets or frames via the second mesh link may be dynamically adapted, e.g., by a controller or a computer that provides information that specifies the assignment or selection to the RAP. Therefore, the communication techniques may improve the communication performance of the mesh network and may allow the mesh network to be dynamically adapted to changing RF conditions and/or different traffic flows (such as traffic flows associated with different types of applications). Consequently, the communication techniques may improve the user quality of experience when using an electronic device (such as a client), a given MAP in the two or more MAPs, the RAP and communicating via the mesh network.

In the discussion that follows, electronic devices or components in a system communicate packets in accordance with a wireless communication protocol, such as: a wireless communication protocol that is compatible with an IEEE 802.11 standard (which is sometimes referred to as ‘Wi-Fi®,’ from the Wi-Fi Alliance of Austin, Texas), Bluetooth, and/or another type of wireless interface (such as another wireless-local-area-network interface). In some embodiments, the IEEE 802.11 standard or communication protocol may include one or more of: IEEE 802.11a, IEEE 802.11b, IEEE 802.11g, IEEE 802.11n, IEEE 802.11ac, IEEE 802.11ax, IEEE 802.11be, IEEE 802.11s or a future IEEE 802.11 standard. Moreover, an access point in the system may communicate with a controller, a computer (such as a cloud-based computer) or a service (e.g., via a gateway) using a wired communication protocol, such as a wired communication protocol that is compatible with an IEEE 802.3 standard (which is sometimes referred to as ‘Ethernet’), e.g., an Ethernet II standard. However, a wide variety of communication protocols may be used in the system, including wired and/or wireless communication. In the discussion that follows, Wi-Fi and Ethernet are used as illustrative examples.

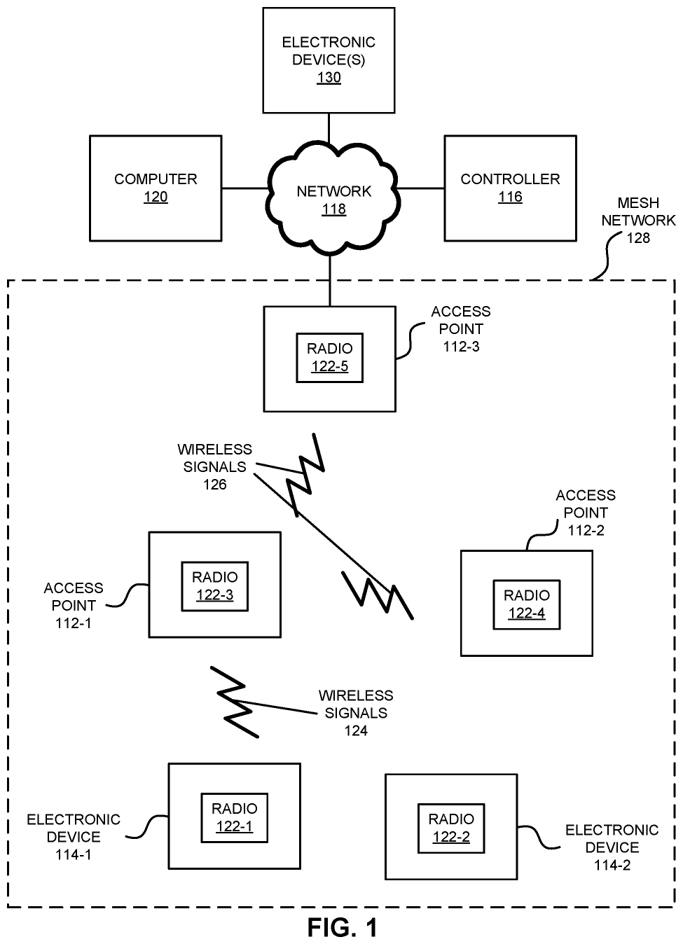

We now describe some embodiments of the communication techniques. FIG. 1 presents a block diagram illustrating an example of a system, which may include components, such as: access points 112, one or more electronic devices 114 (such as cellular telephones, stations or clients, another type of electronic device, etc.), one or more controller (such as controller 116) and/or one or more computers (such as computer 120). In this system, one or more of access points 112 may wirelessly communicate with one or more of the one or more electronic devices 114 using wireless communication that is compatible with an IEEE 802.11 standard. Thus, the wireless communication may occur in, e.g., a 2.4 GHz, a 5 GHz, a 6 GHz, 7 GHz and/or a 60 GHz frequency band. (Note that IEEE 802.11ad communication over a 60 GHz frequency band is sometimes referred to as ‘WiGig.’ In the present discussion, these embodiments are also encompassed by ‘Wi-Fi.’) However, a wide variety of frequency bands may be used. Moreover, access points 112 may communicate with controller 116 and/or computer 108 via network 118 (such as the Internet, an intra-net and/or one or more dedicated links). In addition, access points 112 may communicate with computer 120 via network 118. Note that controller 116 and/or computer 120 may be at the same location as the other components in the system or may be located remotely (i.e., at a different location, such as a cloud-based computer). Moreover, note that access points 112 may be managed and/or configured by controller 116. Furthermore, note that access points 112 may provide access to network 118 (e.g., via an Ethernet protocol) and one or more electronic devices 130 (such as one or more computers or servers), and may be a physical access point or a virtual or ‘software’ access point that is implemented on a computer or an electronic device. While not shown in FIG. 1, there may be additional components or electronic devices, such as a router or a switch.

Additionally, access points 112 and the one or more electronic devices 114 may communicate via wireless communication, and at least some of access points 112 may communicate with each other via wireless communication (such as via wireless signals 126). Notably, one or more of access points 112 and one or more of electronic devices 114 may wirelessly communicate while: transmitting advertising frames or packets on wireless channels, detecting one another by scanning wireless channels, exchanging subsequent data/management frames or packets (such as association requests and responses) to establish a connection, configure security options (e.g., Internet Protocol Security), transmit and receive frames or packets via the connection (which may include the association requests and/or additional information as payloads), etc.

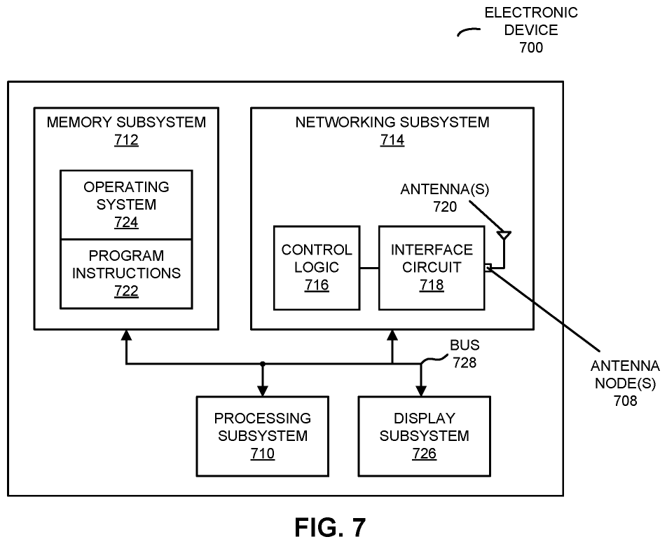

As described further below with reference to FIG. 7, access points 112, the one or more electronic devices 114, controller 116, computer 120 and/or electronic devices 130 may include subsystems, such as a networking subsystem, a memory subsystem and a processor subsystem. In addition, access points 112 and the one or more electronic devices 114 may include radios 122 in the networking subsystems. More generally, access points 112 and the one or more electronic devices 114 can include (or can be included within) any electronic devices with the networking subsystems that enable access points 112 and the one or more electronic devices 114 to wirelessly communicate with each other.

As can be seen in FIG. 1, wireless signals 124 (represented by a jagged line) are transmitted from a radio 122-1 in electronic device 114-1. These wireless signals are received by radio 122-3 in at least one of access points 112, such as access point 112-1. Notably, electronic device 114-1 may transmit frames or packets. In turn, these frames or packets may be received by access point 112-1. This may allow electronic device 114-1 to communicate information to access point 112-1. Note that the communication between, e.g., electronic device 114-1 and access point 112-1 may be characterized by a variety of performance metrics, such as: a data rate, a data rate for successful communication (which is sometimes referred to as a ‘throughput’), an error rate (such as a retry or resend rate), a mean-square error of equalized signals relative to an equalization target, intersymbol interference, multipath interference, a signal-to-noise ratio, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’). In some embodiments, the communication between, e.g., electronic device 114-1 and access point 112-1 may be characterized by an error-rate model, which compares the error rate during communication at the data rate. While instances of radios 122 are shown in the one or more electronic devices 114 and access points 112, one or more of these instances may be different from the other instances of radios 122.

As noted previously, access points 112 may be arranged in a mesh network 128. This mesh network may have a network topology in which access points 112 or nodes relay data in mesh network 128 and access points 112 cooperate in the distribution of data in mesh network 128. Notably, access points 112-1 and 112-2 may be MAPs, and access point 112-3 may be a RAP that is coupled to wired network 118. Access points 112-1 and 112-2 may wireless communicate with each other and/or access point 112-3 via mesh links or paths in mesh network 128. As described further below, at least two of the mesh links used by access point 112-3 may use different bands of frequencies.

Moreover, in mesh network 128, a mesh link from an electronic device (such as electronic device 114-1) to a RAP (such as access point 112-3) may include at least one wireless connection that communicates information to or from electronic device 114-1 with network 118. For example, the mesh path from electronic device 114-1 and access point 112-1 may include zero or more additional MAPs or intermediary access points (or hops) in mesh network 128, such as access point 112-2. Notably, as described further below, in some embodiments electronic device 114-1 may communicate with access point 112-3 via access point 112-1 and/or access point 112-2. In some embodiments, mesh network 128 includes an access point (which is sometimes called an ‘Ethernet mesh electronic device’) that communicates with another access point in mesh network 128 using Ethernet. Note that the MAP that is connected to another uplink MAP via Ethernet is sometimes referred to as an ‘Ethernet-MAP’ or an ‘eMAP.’

In FIG. 1, while access points 112-1 and 112-2 have the ‘option’ to communicate with each other (because they are within communication or wireless range of each other) in a typical IEEE 802.11 network, the network design may involve operating elements that prevent a network loop condition. Thus, while it is ok to ‘connect’, from the perspective of network packet or frame forwarding, FIG. 1 should not be construed as to imply that a network loop condition exists if this condition is detrimental to the network. Note that the hierarchy (or tree) of access points 112 in mesh network 128 may dynamically change based at least in part on one or more of the communication-performance metrics of the mesh paths or links in mesh network 128, such as based on changes in an RF environment.

As noted previously, in a mesh network the communication performance may change as a function of time, e.g., because of changes to the RF environment, a number of clients (such as electronic device 114-1) and/or traffic flows associated with a type of application (such as voice, video or file download). However, it is often difficult to adapt existing mesh network to such changes, which can degrade the communication performance.

In order to address these challenges, access point 112-3 may perform the communication techniques. As noted previously, during operation access point 112-3 may communicate with electronic device 114-1 via access point 112-1 and/or access point 112-2. The communication between access point 112-3 and access point 112-1 and/or access point 112-2 may involve or use two or more concurrent mesh links in mesh network 128.

Notably, during operation, access point 112-3 may communicate, via a mesh link in the two or more concurrent mesh links, packets or frames with access point 112-1 and/or access point 112-2, where the mesh link uses a band of frequencies, and where the packets or frames have a priority. Moreover, access point 112-3 may communicate, via a second mesh link in the two or more concurrent mesh links, second packets or second frames with access point 112-1 and/or access point 112-2, where the second mesh link uses a second band of frequencies that is different from the band of frequencies, and where the second packets or second frames have a second priority that is less than the priority of the packets or frames. For example, the band of frequencies may include a 6 GHz band of frequencies, and the second band of frequencies may include a 2.4 or 5 GHz band of frequencies.

Moreover, the priority may be associated with a type of application and the second priority may be associated with a second type of application that is different from the type of application. For example, the type of application may include voice (such as VoIP), video (such as a video-conferencing application) or file download. Alternatively, or additionally, the priority may be specified by an access category associated with the packets or frames and the second priority may be specified by a second access category associated with the second packets or second frames.

Furthermore, in some embodiments, access point 112-3 may assign or select the link for the packets or frames and the second link for the second packets or frames. For example, access point 112-3 may assign or select the links based at least in part on the priority and the second priority, the access category and the second access category, the type of application and the second type of application, and/or one or more communication-performance metrics for traffic flows from the one or more electronic devices 130, where a traffic flow in the traffic flows includes the packets or frames and second traffic flow in the traffic flows includes the second packets or second frames. Alternatively, or additionally, access point 112-3 may assign or select the link and the second link based at least in part on information (such as a number of clients, one or more second communication-performance metrics, etc.) associated with operation of access points 112-1 and 112-2, which is received from access points 112-1 and/or 112-2. Note that this information may be received from access points 112-1 and 112-2 (such as periodically, e.g., every 100 ms, or as needed, such as when the information changes).

In some embodiments, access point 112-3 may receive, from controller 116 and/or computer 120, second information that specifies the priority and the second priority. Note that the second information may be received from controller 116 and/or from computer 120 (such as periodically, e.g., every 100 ms, or as needed, such as when the second information changes). Moreover, the second information may be associated with the traffic flows between the one or more electronic devices 130 and access point 112-3. For example, the second information may be associated with or may include: the priority and the second priority, the access category and the second access category, the type of application and the second type of application, and/or the communication-performance metrics associated with the traffic flows. Furthermore, the one or more electronic devices 130 may provide information about the traffic flows to controller 116 and/or computer 120, or access point 112-3 may information about the traffic flows to controller 116 and/or computer 120. Alternatively, the second information may be received before the traffic flows begin. Thus, in some embodiments, the assignment or selection may occur before any data or communication-performance metrics associated with the traffic flows is available to access point 112-3. Note that in some embodiments the second information may specify the link and the second link. (Therefore, in some embodiments, controller 116 and/or computer 120 provides instructions to access point 112-3 about the links to use with the traffic flows.) Consequently, in some embodiments, the assignment or the selection occurs locally (or is performed locally by access point 112-3), remotely (e.g., is performed by controller 116 and/or computer 120) or both.

Note that controller 116 and/or computer 120 may compute the second information using a pretrained predictive model, such as a pretrained machine-learning model or a neural network (such as a convolutional neural network technique, an autoencoder neural network or another type of neural network technique). For example, the pretrained machine-learning model may be trained using a training dataset and a supervised-learning technique, such as: a support vector machine technique, a classification and regression tree technique, logistic regression, LASSO, linear regression, and/or another linear or nonlinear supervised-learning technique. The pretrained predictive model uses the priority and the second priority, the access category and the second access category, the type of application and the second type of application, and/or the communication-performance metrics as inputs and may output the second information. In some embodiments, controller 116 and/or computer 120 may dynamically retrain the pretrained predictive model and/or may determine mesh-network-management heuristics based at least in part on data associated with the traffic flows. Notably, access point 112-3 may send data (such as priorities, access categories, types of applications and/or communication-performance metrics) associated with the traffic flows to controller 116 and/or computer 120, which may use the data to dynamically retrain the pretrained predictive model and/or to determine the mesh-network-management heuristics.

In these ways, access point 112-3 may use the communication techniques to improve communication performance in mesh network 128. Notably, access point 112-3 may using different links in different bands of frequencies to convey packets or frames associated with traffic flows having different priorities, different access categories, and/or that are associated with different types of applications. Moreover, access point 112-3 (or controller 116 and/or computer 120) may dynamically adapt or change the assigned or selected links based at least in part on changes in the RF environment and/or communication-performance metrics in mesh link 128 and/or that are associated with the traffic flows. Therefore, the communication techniques may improve the communication performance of mesh network 128 and may allow mesh network 128 to be dynamically adapted to changing RF conditions and/or different traffic flows (such as traffic flows associated with different types of applications). Consequently, the communication techniques may improve the user experience when using electronic devices 114, access points 112 and communicating via mesh network 128.

In the described embodiments, processing a frame or a packet in one of access points 112 or a given one of the one or more electronic devices 114 may include: receiving wireless signals 124 with the frame or packet; decoding/extracting the frame or packet from the received wireless signals 124 to acquire the frame or packet; and processing the frame or packet to determine information contained in the frame or packet.

Although we describe the network environment shown in FIG. 1 as an example, in alternative embodiments, different numbers or types of electronic devices or components may be present. For example, some embodiments comprise more or fewer electronic devices or components. Therefore, in some embodiments there may be fewer or additional instances of at least some of access points 112, one or more electronic devices 114 controller 116 and/or computer 120. As another example, in another embodiment, different electronic devices are transmitting and/or receiving frames or packets.

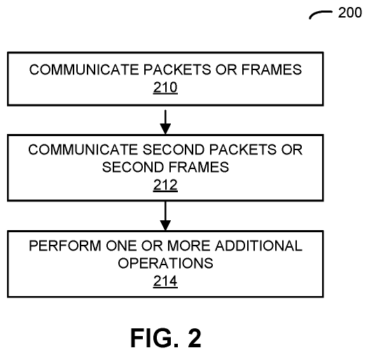

We now describe embodiments of the method. FIG. 2 presents an example of a flow diagram illustrating an example method 200 for communicating in a mesh network. Moreover, method 200 may be performed by a RAP, such as access point 112-3 in FIG. 1.

During operation, the RAP may communicate, via a mesh link in two or more concurrent mesh links in the mesh network, packets or frames (operation 210) with one or more MAPs in the mesh network, where the mesh link uses a band of frequencies, and where the packets or frames have a priority. Then, the RAP may communicate, via a second mesh link in the two or more concurrent mesh links, second packets or second frames (operation 212) with the one or more MAPs, where the second mesh link uses a second band of frequencies that is different from the band of frequencies, and where the second packets or second frames have a second priority that is less than the priority.

Note that the band of frequencies may include a 6 GHz band of frequencies, and the second band of frequencies may include a 2.4 or 5 GHz band of frequencies.

Moreover, the one or more MAPs may include two MAPs.

Furthermore, the priority may be associated with a type of application and the second priority may be associated with a second type of application that is different from the type of application. Additionally, the type of application may include voice (such as VoIP), video (such as a video-conferencing application, a video gaming, etc.) or file download. In some embodiments, the priority may be specified by an access category associated with the packets or frames and the second priority may be specified by a second access category associated with the second packets or second frames.

In some embodiments, the RAP may optionally perform one or more additional operations (operation 214). Notably, the RAP may receive, associated with a controller of the RAP or a computer (such as a cloud-based computer), information that specifies the priority and the second priority. Furthermore, the information may be associated with traffic flows between one or more electronic devices and the RAP, where a traffic flow in the traffic flows includes the packets or frames and second traffic flow in the traffic flows includes the second packets or second frames. For example, the information may be associated with communication-performance metrics associated with the traffic flows. Additionally, the information may be received before the traffic flows begin. In some embodiments, the information may specify the link and the second link.

In some embodiments of method 200, there may be additional or fewer operations. Moreover, there may be different operations. Furthermore, the order of the operations may be changed, and/or two or more operations may be combined into a single operation.

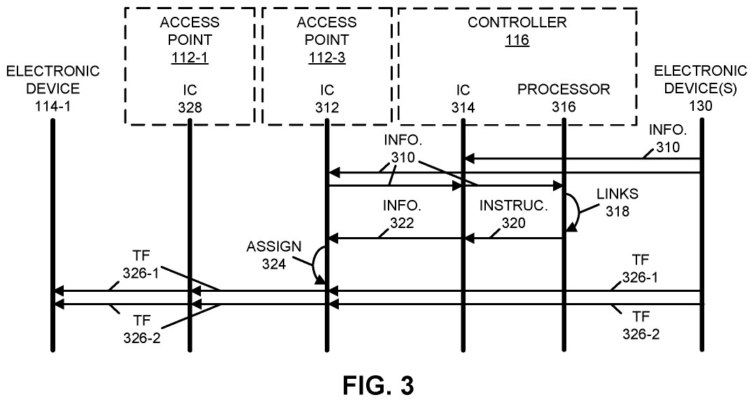

FIG. 3 presents a drawing illustrating an example of communication between one or more electronic devices 130, controller 116, access point 112-1, access point 112-3 and electronic device 114-1. In FIG. 3, the one or more electronic devices 130 may provide information 310 about traffic flows 324 to controller 116 directly or via interface circuit (IC) 312 in access point 112-3.

After receiving information 310, an interface circuit 314 in controller 116 may provide information 310 to a processor 316 in controller 116. Then, processor 316 may compute information specifying links 318 to be used in a mesh network to communicate traffic flows 324 (e.g., using a pretrained predictive model with information 310 as an input and that outputs the information specifying links 318). Moreover, processor 316 may instruct 320 interface circuit 314 to provide information 322 specifying links 318 to access point 112-3.

Next, after receiving information 322, interface circuit 312 may assign 324 packets or frames having a priority in traffic flow (TF) 326-1 to be communicated between access points 112-3 and 112-1 using a link in links 318 associated with a band of frequencies, and may assign 324 second packets or second frames having a second (different) priority in traffic flow 326-2 to be communicated between access points 112-3 and 112-1 using a second link in links 318 associated with a second (different) band of frequencies. Note that in FIG. 3, links 318 may already be established between access points 112-1 and 112-3.

Furthermore, the one or more electronic devices 130 may provide the packets or frames in traffic flow 326-1 and the second packets or second frames in traffic flow 326-2 to access point 112-3. After receiving the packets or frames in traffic flow 326-1, interface circuit 312 may provide the packets or frames in traffic flow 326-1 to an interface circuit 328 in access point 112-2 using the link in links 318, which then provides the packets or frames in traffic flow 326-1 to electronic device 114-1. Additionally, after receiving the second packets or second frames in traffic flow 326-2, interface circuit 312 may provide the second packets or second frames in traffic flow 326-2 to interface circuit 328 using the second link in links 318, which the provides the second packets or second frames in traffic flow 326-2 to electronic device 114-1.

While FIG. 3 illustrates some operations using unilateral or bilateral communication (which are, respectively, represented by one-sided and two-sided arrows), in general a given operation in FIG. 3 may involve unilateral or bilateral communication.

We now further describe embodiments of the communication techniques. In existing mesh networks, a mesh link between a RAP and a MAP may use a link in a band of frequencies, such as a 2.4, 5, 6 GHz, etc. band of frequencies. The static nature of such a mesh-network design often impacts the quality of experience and throughput of clients that connect to the MAP. Moreover, the link between the RAP and the MAP may become saturated because of prevailing RF conditions, an increase in the number of clients that the MAP serves, etc. The current mesh-network design typically does not provide mitigation of these problems. Furthermore, the problems may be increased with traffic types, such as VoIP, video (such as video conferencing, video gaming, etc.) that often need additional resources (e.g., bandwidth, extra airtime, etc.) to provide an expected quality of experience to clients.

Note that IEEE 802.11s is a wireless local area network (WLAN) standard for mesh networking, which defines how wireless electronic devices can interconnect to create a WLAN mesh network. This is often used for relatively fixed topologies and wireless ad-hoc networks. Moreover, IEEE 802.11s describes a wireless mesh network (WMN) with routing capabilities at the media access control (MAC) layer. Note that path selection is used to refer to MAC-address based routing and to differentiate it from conventional Internet protocol (IP) routing.

Typically, the WMN implements a single broadcast domain and, thus, integrates seamlessly with other IEEE 802.11-compatible networks. Notably, IEEE 802.11s supports transparent delivery of unicast, multicast and broadcast frames to destinations in- and outside of the mesh basic service set (MBSS) electronic devices that form the mesh network (which are sometimes referred to as ‘mesh stations,’ ‘mesh STAs’ or MAPs). MAPs usually forward frames wirelessly, but do not communicate with non-mesh stations. However, a MAP may be collocated with other IEEE 802.11 entities. Note that IEEE 802.11s does not specify handling or use of multiple links between MAPs that are one, two, etc. hops from the RAP (which is sometimes referred to as a portal MAP).

In some embodiments of the communication techniques multiple links are simultaneously or concurrently operational between a RAP and the MAP, and between the MAP and a second MAP/eMAP. For example, there may be a link that uses a 2.4 GHz band of frequencies and a second link that uses a 5 GHz band of frequencies between the RAP and the MAP. Moreover, there may be three links that use a 2.4 GHz, a 5 GHz and a 6 GHz band of frequencies (respectively) between the MAPs and an eMAP.

Moreover, in some embodiments, a management entity (such as controller 116 and/or computer 120) may analyze data received from the RAP and/or the MAP (e.g., continuously, periodically or as needed) and may subsequently provide the RAP and the MAP guidance or instructions to allocate network resources on a selected link or selected links in the mesh network. For example, the network resources may include airtimes that are allocated to the RAP and/or the MAP based at least in part on their loading, communication performances and/or (more generally) information associated with operation of the RAP and/or the MAP. In general, the allocated network resources for the RAP and the MAP may be different from each other.

In some embodiments, a link between mesh components or entities (such as the RAP or the MAP) may be dedicated to carry a certain traffic type (e.g., video). However, in embodiments where a link between mesh components or entities is shared by various traffic types, packets or frames associated with a lower-priority traffic type may be throttled to give precedence to a higher-priority traffic type (such as VoIP or video traffic).

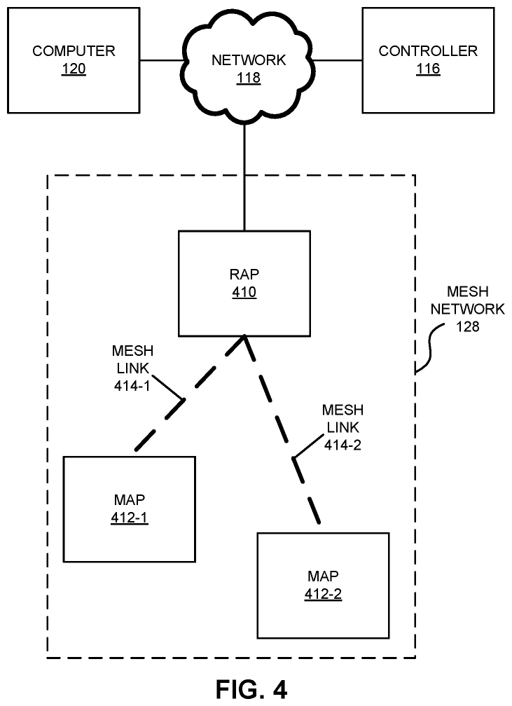

Note that in some embodiments, a mesh entity (such as the RAP) may dynamically select among multiple mesh links for a given traffic type to improve a quality of experience. This is shown in FIG. 4, which presents a drawing illustrating an example of communication in mesh network 128. Notably, a RAP 410 (such as access point 112-3) may communicate with MAPs 412 (such as access points 112-1 and 112-2) using links 414. Notably, link 414-1 may use a band of frequencies (such as a 6 GHz band of frequencies) and link 414-2 may use a second (different) band of frequencies (such as a 2.4 or 5 GHz band of frequencies). Moreover, link 414-1 may be used to communicate packets or frames having a priority and link 414-2 may be used to communicate second packets or second frames having a second (lower) priority. Thus, instead of using a single link (such as in existing mesh networks), the mesh network in FIG. 4 may use multiple links with priority-based traffic segmentation to avoid mesh-network congestion and to provide improved throughput to a client.

For example, RAP 410 may send all VoIP traffic over link 414-1 that uses a 6.0 GHz band of frequencies. Alternatively, RAP 410 may send 50% of video traffic on link 414-2 that uses a 5 GHz band of frequencies and 50% on link 414-1 that uses a 6.0 GHz band of frequencies. Moreover, RAP 410 may send all the multicast traffic to link 414-1 or to link 414-2 when there is sufficient capacity. (While FIG. 4 illustrates a number of RAPs 410 and mesh links 414, in other embodiments there may be fewer or additional RAPs 410 and/or mesh links 414.)

Because of dynamic changes in radio conditions, RAP 410 may receive an instruction from controller 116 and/or computer 120 to use a different link to provide consistent service to a client. Thus, RAP 410 may change from a link that uses a 2.4 GHz band of frequencies to a second link that uses a 5 GHz band of frequencies or may change from a second link that uses a 5 GHz band of frequencies to a third link that uses a 6 GHz band of frequencies.

Note that RAP 410 may also participate in assigning or selecting links 414. For example, RAP 410 may, based at least in part on its current load, decide to allocate links 414 that use the 2.4, 5 or 6 GHz band of frequencies to MAPs 412. In some embodiments, RAP 410 may reserve/allocate a link that uses the 2.4 GHz band of frequencies for a best effort traffic type and a second link that the 5 GHz band of frequencies for VoIP to clients of MAPs 412 without sacrificing throughput to clients of RAP 410.

Moreover, RAP 410 may determine mesh-network-management heuristics and/or may send data to controller 116 and/or computer 120, so controller 116 and/or computer 120 can dynamically retrain a predictive model and/or determine the mesh-network-management heuristics that may be used to more accurately allocate network resources in the mesh network, e.g., to MAPs 412. Thus, in some embodiments, RAP 410 may report data and second data received from one or more MAPs in the mesh network to controller 116 and/or computer 120, which may learn over time based at least in part on the data and may provide feedback or instructions to RAP 410 on how to allocate links 414 to the one or more MAPs and/or different traffic flows. These approaches may improve throughput in the mesh networks and, thus, may provide improved service to clients.

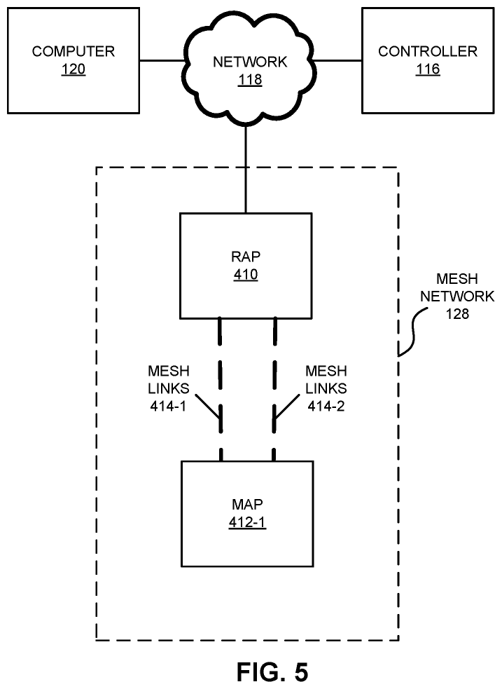

While FIG. 4 illustrates the use of links 414 to communicate between RAP 410 and MAPs 412, in other embodiments multiple links 414 may be used to communicate between RAP 410 and a single MAP, such as MAP 412-1. This is shown in FIG. 5, which presents a drawing illustrating an example of communication in mesh network 128.

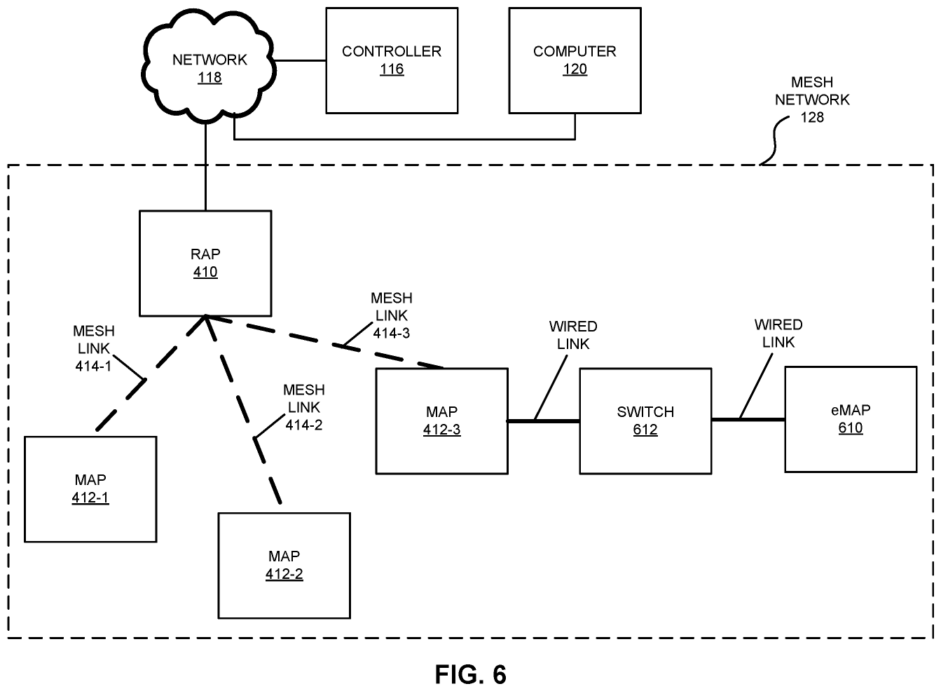

In some embodiments, a mesh entity (such as the RAP) may dynamically select among multiple mesh links for a given traffic type to improve a quality of experience for an eMAP, This is shown in FIG. 6, which presents a drawing illustrating an example of communication in mesh network 128. Notably, eMAP 610 may communicate with MAP 412-3 via wired communication, e.g., via an Ethernet cable. Note that eMAP 610 may be within one hop of MAP 412-3.

During operation, RAP 410 may receive data from MAPs 412 and eMAP 610. Based at least in part on a current load of RAP 410, RF conditions, etc., RAP 410 may evaluate the data received from MAPs 412 and eMAP 610, and may assign or select links 414 to use for a given traffic type. These assignments or selections may ensure that a client connected to eMAP 610 has good throughput and, more generally, service.

Alternatively, or additionally, RAP 410 may receive an instruction assigning or selecting links 414 from controller 116 and/or computer 120, which may determine the assignment or the selection using a pretrained predictive model and/or mesh-network-management heuristics. The assignment or selection may ensure that the traffic type to the clients has good throughput.

In some embodiments, eMAP 610 is coupled to MAP 412-3 via optional switch 612. For example, switch 612 may be connected to a wired Ethernet port in MAP 412-3. This switch may have additional MAPs connected to it. In these embodiments, there may be several approaches for allocating links 414 to MAPs 412.

In a first approach, RAP 410 may receive data from MAPs 412 that it serves, including any sub-tending MAPs from the 1st hop MAP that are connected via a wired connection, such as eMAP 610. Based at least in part on the current load, RF conditions, traffic type, etc., RAP 410 may evaluate the received data from its 1st hop and wired-MAPs and respond to respective MAPs with information specifying links 414 that are suitable for the current environment and traffic type. MAPs 412 and e-MAP 610 may use the assigned or selected links 414 to provide equitable/good wireless service to time critical, delay-sensitive and/or jitter-sensitive traffic flows (such as traffic flows that originate at clients).

In the second approach, RAP 410 may send the received data to controller 116 and/or computer 120 that, e.g., using a pretrained predictive model and/or mesh-network-management heuristics, may determine and send feedback to RAP 410 to allocate links 414 to MAPs 412 and e-MAP 610 equitably, such that clients have good throughput.

In general terms, the assignment or selection sequence may be: prior to determining the traffic type or access category, the first few packets or frames may be conveyed on any of the operating links; then, the RAP may analyze the packets or frames and may determine the link to be used for this traffic type or access category; and after the given traffic type or access category is determined, subsequent packets or frames in the traffic flow may be conveyed via the assigned or selected link for the given traffic type or access category. For example, a link using the 6 GHz band of frequencies may convey VoIP and video-conferencing traffic flows, a second link using the 5 GHz band of frequencies may convey video, and a third link using a 2.4 GHz band of frequencies may convey standard Web traffic (such as online shopping, etc.).

In the preceding embodiments, RAP 410 may receive information from another component via beacons, management frames or control frames. For example, RAP 410 may provide a beacon with a vendor specific attribute requesting information from a given MAP. In response, the given MAP may provide a beacon with the information associated with the given MAP. Note that the beacons may be provided periodically, such as every 100 ms.

Alternatively, or additionally, RAP 410 may provide a management frame or a control frame with an information element requesting information from a given MAP. In response, the given MAP may provide a management frame or a control frame with the information associated with the given MAP. Note that the management frames or the control frames may be provided periodically, such as every 100 ms. In some embodiments, the management frames or the control frames may be compatible with an inter-access-point protocol.

We now describe embodiments of an electronic device, which may perform at least some of the operations in the communication techniques. For example, the electronic device may include a component in the system in FIG. 1, such as one of: access points 112, one or more electronic devices 114, controller 116, computer 120 and/or electronic devices 130. FIG. 7 presents a block diagram illustrating an electronic device 700 in accordance with some embodiments. This electronic device includes processing subsystem 710, memory subsystem 712, and networking subsystem 714. Processing subsystem 710 includes one or more devices configured to perform computational operations. For example, processing subsystem 710 can include one or more microprocessors, ASICs, microcontrollers, programmable-logic devices, graphical processor units (GPUs) and/or one or more digital signal processors (DSPs).

Memory subsystem 712 includes one or more devices for storing data and/or instructions for processing subsystem 710 and networking subsystem 714. For example, memory subsystem 712 can include dynamic random-access memory (DRAM), static random-access memory (SRAM), and/or other types of memory (which collectively or individually are sometimes referred to as a ‘computer-readable storage medium’). In some embodiments, instructions for processing subsystem 710 in memory subsystem 712 include: one or more program modules or sets of instructions (such as program instructions 722 or operating system 724), which may be executed by processing subsystem 710. Note that the one or more computer programs may constitute a computer-program mechanism. Moreover, instructions in the various modules in memory subsystem 712 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 710.

In addition, memory subsystem 712 can include mechanisms for controlling access to the memory. In some embodiments, memory subsystem 712 includes a memory hierarchy that comprises one or more caches coupled to a memory in electronic device 700. In some of these embodiments, one or more of the caches is located in processing subsystem 710.

In some embodiments, memory subsystem 712 is coupled to one or more high-capacity mass-storage devices (not shown). For example, memory subsystem 712 can be coupled to a magnetic or optical drive, a solid-state drive, or another type of mass-storage device. In these embodiments, memory subsystem 712 can be used by electronic device 700 as fast-access storage for often-used data, while the mass-storage device is used to store less frequently used data.

Networking subsystem 714 includes one or more devices configured to couple to and communicate on a wired and/or wireless network (i.e., to perform network operations), including: control logic 716, an interface circuit 718 and one or more antennas 720 (or antenna elements). (While FIG. 7 includes one or more antennas 720, in some embodiments electronic device 700 includes one or more antenna nodes, connectors or pads, such as nodes 708, e.g., an antenna node, a connector or a pad, which can be coupled to the one or more antennas 720. Thus, electronic device 700 may or may not include the one or more antennas 720.) For example, networking subsystem 714 can include a Bluetooth networking system, a cellular networking system (e.g., a 3G/4G/5G network such as UMTS, LTE, 5G/5GNC, etc.), a USB networking system, a networking system based on the standards described in IEEE 802.11 (e.g., a Wi-Fi networking system), an Ethernet networking system, and/or another networking system.

In some embodiments, a transmit antenna radiation pattern of electronic device 700 may be adapted or changed using pattern shapers (such as reflectors) in one or more antennas 720 (or antenna elements), which can be independently and selectively electrically coupled to ground to steer the transmit antenna radiation pattern in different directions. Thus, if one or more antennas 720 includes N antenna-radiation-pattern shapers, the one or more antennas 720 may have 2^{N} different antenna-radiation-pattern configurations. More generally, a given antenna radiation pattern may include amplitudes and/or phases of signals that specify a direction of the main or primary lobe of the given antenna radiation pattern, as well as so-called ‘exclusion regions’ or ‘exclusion zones’ (which are sometimes referred to as ‘notches’ or ‘nulls’). Note that an exclusion zone of the given antenna radiation pattern includes a low-intensity region of the given antenna radiation pattern. While the intensity is not necessarily zero in the exclusion zone, it may be below a threshold, such as 3 dB or lower than the peak gain of the given antenna radiation pattern. Thus, the given antenna radiation pattern may include a local maximum (e.g., a primary beam) that directs gain in the direction of an electronic device that is of interest, and one or more local minima that reduce gain in the direction of other electronic devices that are not of interest. In this way, the given antenna radiation pattern may be selected so that communication that is undesirable (such as with the other electronic devices) is avoided to reduce or eliminate adverse effects, such as interference or crosstalk.

Networking subsystem 714 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 700 may use the mechanisms in networking subsystem 714 for performing simple wireless communication between the electronic devices, e.g., transmitting frames and/or scanning for frames transmitted by other electronic devices.

Within electronic device 700, processing subsystem 710, memory subsystem 712, and networking subsystem 714 are coupled together using bus 728. Bus 728 may include an electrical, optical, and/or electro-optical connection that the subsystems can use to communicate commands and data among one another. Although only one bus 728 is shown for clarity, different embodiments can include a different number or configuration of electrical, optical, and/or electro-optical connections among the subsystems.

In some embodiments, electronic device 700 includes a display subsystem 726 for displaying information on a display, which may include a display driver and the display, such as a liquid-crystal display, a multi-touch touchscreen, etc.

Electronic device 700 can be (or can be included in) any electronic device with at least one network interface. For example, electronic device 700 can be (or can be included in): a desktop computer, a laptop computer, a subnotebook/netbook, a server, a computer, a mainframe computer, a cloud-based computer, a tablet computer, a smartphone, a cellular telephone, a smartwatch, a wearable device, a consumer-electronic device, a portable computing device, an access point, a transceiver, a controller, a radio node, a router, a switch, communication equipment (such as an Evolved Node B or eNodeB, a next generation Node-B or Ng-NodeB and, more generally, a base station in a cellular-telephone network), a wireless dongle, test equipment, and/or another electronic device.

Although specific components are used to describe electronic device 700, in alternative embodiments, different components and/or subsystems may be present in electronic device 700. For example, electronic device 700 may include one or more additional processing subsystems, memory subsystems, networking subsystems, and/or display subsystems. Additionally, one or more of the subsystems may not be present in electronic device 700. Moreover, in some embodiments, electronic device 700 may include one or more additional subsystems that are not shown in FIG. 7. Also, although separate subsystems are shown in FIG. 7, in some embodiments some or all of a given subsystem or component can be integrated into one or more of the other subsystems or component(s) in electronic device 700. For example, in some embodiments program instructions 722 are included in operating system 724 and/or control logic 716 is included in interface circuit 718.

Moreover, the circuits and components in electronic device 700 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit (which is sometimes referred to as a ‘communication circuit’ or a ‘means for communication’) may implement some or all of the functionality of networking subsystem 714 (and, more generally, of electronic device 700). The integrated circuit may include hardware and/or software mechanisms that are used for transmitting wireless signals from electronic device 700 and receiving signals at electronic device 700 from other electronic devices. Aside from the mechanisms herein described, radios are generally known in the art and hence are not described in detail. In general, networking subsystem 714 and/or the integrated circuit can include any number of radios. Note that the radios in multiple-radio embodiments function in a similar way to the described single-radio embodiments.

In some embodiments, networking subsystem 714 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals)

In some embodiments, an output of a process for designing the integrated circuit, or a portion of the integrated circuit, which includes one or more of the circuits described herein may be a computer-readable medium such as, for example, a magnetic tape or an optical or magnetic disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII), Electronic Design Interchange Format (EDIF), OpenAccess (OA), or Open Artwork System Interchange Standard (OASIS). Those of skill in the art of integrated circuit design can develop such data structures from schematics of the type detailed above and the corresponding descriptions and encode the data structures on the computer-readable medium. Those of skill in the art of integrated circuit fabrication can use such encoded data to fabricate integrated circuits that include one or more of the circuits described herein.

While the preceding discussion used Wi-Fi and/or Ethernet communication protocols as illustrative examples, in other embodiments a wide variety of communication protocols and, more generally, communication techniques may be used. Thus, the communication techniques may be used in a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the communication techniques may be implemented using program instructions 722, operating system 724 (such as a driver for interface circuit 718) or in firmware in interface circuit 718. Alternatively, or additionally, at least some of the operations in the communication techniques may be implemented in a physical layer, such as hardware in interface circuit 718.

Additionally, while the preceding embodiments illustrated the use of wireless signals in one or more bands of frequencies, in other embodiments of these signals may be communicated in one or more bands of frequencies, including: a microwave frequency band, a radar frequency band, 900 MHz, 2.4 GHz, 5 GHz, 6 GHz, 7 GHz, 60 GHz, and/or a band of frequencies used by a Citizens Broadband Radio Service or by LTE (and, more generally, a band of frequencies used to communicate data, e.g., in a cellular-telephone network, such as a microcell, a small cell, etc.). In some embodiments, the communication between electronic devices uses multi-user transmission, such as OFDM and/or OFDMA.

In the preceding description, we refer to ‘some embodiments.’ Note that ‘some embodiments’ describes a subset of all of the possible embodiments but does not always specify the same subset of embodiments. Moreover, note that numerical values in the preceding embodiments are illustrative examples of some embodiments. In other embodiments of the communication techniques, different numerical values may be used.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown but is to be accorded the widest scope consistent with the principles and features disclosed herein.

What is claimed is:

1. A root access point (RAP), comprising:
one or more interface circuits configured to communicate with one or more mesh access points (MAPs) via two or more concurrent mesh links in a mesh network and one or more electronic devices in a wired network, wherein the RAP is configured to:
communicate, via a mesh link in the two or more concurrent mesh links, packets or frames with the one or more MAPs, wherein the mesh link uses a band of frequencies, and wherein the packets or frames have a priority; and
communicate, via a second mesh link in the two or more concurrent mesh links, second packets or second frames with the one or more MAPs, wherein the second mesh link uses a second band of frequencies that is different from the band of frequencies, and wherein the second packets or second frames have a second priority that is less than the priority.

2. The RAP of claim 1, wherein the band of frequencies comprises a 6 GHz band of frequencies, and the second band of frequencies comprises a 2.4 or 5 GHz band of frequencies.

3. The RAP of claim 1, wherein the one or more MAPs comprises two MAPs.

4. The RAP of claim 1, wherein the priority is associated with a type of application and the second priority is associated with a second type of application that is different from the type of application.

5. The RAP of claim 4, wherein the type of application comprises voice, video or file download.

6. The RAP of claim 1, wherein the priority is specified by an access category associated with the packets or frames and the second priority is specified by a second access category associated with the second packets or second frames.

7. The RAP of claim 1, wherein the RAP is configured to receive, associated with a controller of the RAP or a computer, information that specifies the priority and the second priority.

8. The RAP of claim 7, wherein the information is associated with traffic flows between the one or more electronic devices and the RAP; and
wherein a traffic flow in the traffic flows comprises the packets or frames and second traffic flow in the traffic flows comprises the second packets or second frames.

9. The RAP of claim 7, wherein the information is associated with communication-performance metrics associated with the traffic flows.

10. The RAP of claim 7, wherein the information is received before the traffic flows begin.

11. The RAP of claim 1, wherein the RAP is configured to receive, associated with a controller of the RAP or a computer, information that specifies the link and the second link.

12. The RAP of claim 1, wherein the communication of the packets or the frames and the second packets or second frames may be compatible with an Institute of Electrical and Electronics Engineers (IEEE) 802.11 communication protocol.

13. A non-transitory computer-readable storage medium for use in conjunction with a root access point (RAP), the computer-readable storage medium storing program instructions, wherein, when executed by the RAP, the program instructions cause the RAP to perform operations comprising:
communicating, via a mesh link in two or more concurrent mesh links in a mesh network, packets or frames with one or more MAPs in the mesh network, wherein the mesh link uses a band of frequencies, and wherein the packets or frames have a priority; and
communicating, via a second mesh link in the two or more concurrent mesh links, second packets or second frames with the one or more MAPs, wherein the second mesh link uses a second band of frequencies that is different from the band of frequencies, and wherein the second packets or second frames have a second priority that is less than the priority.

14. The non-transitory computer-readable storage medium of claim 13, wherein the band of frequencies comprises a 6 GHz band of frequencies, and the second band of frequencies comprises a 2.4 or 5 GHz band of frequencies.

15. The non-transitory computer-readable storage medium of claim 13, wherein the priority is associated with a type of application and the second priority is associated with a second type of application that is different from the type of application.

16. The non-transitory computer-readable storage medium of claim 13, wherein the RAP is configured to receive, associated with a controller of the RAP or a computer, information that specifies the priority and the second priority.

17. A method for communicating in a mesh network, comprising:
by a root access point (RAP):
communicating, via a mesh link in two or more concurrent mesh links in the mesh network, packets or frames with one or more MAPs in the mesh network, wherein the mesh link uses a band of frequencies, and wherein the packets or frames have a priority; and
communicating, via a second mesh link in the two or more concurrent mesh links, second packets or second frames with the one or more MAPs, wherein the second mesh link uses a second band of frequencies that is different from the band of frequencies, and wherein the second packets or second frames have a second priority that is less than the priority.

18. The method of claim 17, wherein the band of frequencies comprises a 6 GHz band of frequencies, and the second band of frequencies comprises a 2.4 or 5 GHz band of frequencies.

19. The method of claim 17, wherein the priority is associated with a type of application and the second priority is associated with a second type of application that is different from the type of application.

20. The method of claim 17, wherein the RAP is configured to receive, associated with a controller of the RAP or a computer, information that specifies the priority and the second priority.
